(19) United States
(12) Patent Application Publication
(10) Pub. No.: US 2016/0156610 A1
(43) Pub. Date: Jun. 2, 2016

(54) Message Pushing System And Method

(71) Applicants: Inventec (Pudong) Technology Corporation, Shanghai (CN); Inventec Corporation, Taipei City (TW)

(72) Inventor: Long Chen, Shanghai (CN)

(21) Appl. No.: 14/663,094

(22) Filed: Mar. 19, 2015

(30) Foreign Application Priority Data
Nov. 27, 2014 (CN) 201410707584.6

(51) Int. Cl. H04L 29/06; H04L 29/08; H04L 12/58

(52) U.S. Cl. CPC H04L 63/083; H04L 51/04; H04L 67/26

(57) ABSTRACT

A message pushing system and method are provided, where a message pushing server receives a push message and generates a message identification corresponding thereto, a pushing cloud pushes the message identification to an application corresponding thereto, the application provides the message identification and a verification token to a message pushing server for a verification, and then the message pushing server pushes the push message corresponding thereto to the application by using a safety connection, whereby the technical efficacy of a lowered message pushing cost and an increased message pushing safety may be achieved.

### CROSS-REFERENCE TO RELATED APPLICATION

This application claims the benefit of Chinese Patent Application No. 201410707584.6, filed Nov. 27, 2014.

### BACKGROUND OF THE RELATED ART

1. Technical Field

The present invention relates to a message pushing system and method, and particularly to a high-safety message pushing system and method.

2. Related Art

For the currently available mobile devices, their message transmission is performed by an email, an online communication, a text message, a multimedia message, etc. However, the email message transmission is not achieved online, the online communication transmission lacks of safety, and the others require an additional cost. Further, they all have the issue of an unguaranteed reach rate.

In response, a message pushing method has been set forth as another message transmission manner. At present, two message pushing methods are available. One is pushing the message by self-establishing a message pushing system, requiring more servers working together to promote an error acceptance rate of the system and a technical maintenance group resulting in a relatively higher cost. The other one is achieved by using the message pushing service provided by the currently available cloud for the client ends. However, this policy has its biggest problem of unguaranteed safety—the pushed message might have a considerably high risk when the cloud safety has a safety leakage.

In view of the above, it may be known that there has long been the issue of a relatively higher cost or a relatively lower safety of the message pushing. Therefore, there is quite a need to set forth an improvement means to settle down this problem.

### SUMMARY

In view of the issue of an exceedingly high cost or a lower safety of the message pushing encountered in the prior art, the present invention provides a message pushing system and method.

According to the present invention, the message pushing system comprises a message pushing server, comprising a message receive module, receiving a pushing message; a generation module, generating a message identification corresponding to the pushing message; a pushing module, pushing the message identification to at least a pushing cloud; a pushing server receive module, receiving the message identification and a verification token; a verification module, verifying the message identification and the verification token; and a pushing server transmission module, transmitting the pushing message corresponding to the message identification when the message identification and the verification token passes the verification.

the pushing cloud, comprising: a cloud receive module, receiving the message identification from the message pushing server pushing module; and a cloud pushing module, pushing the message identification to a pushing application corresponding thereto.

the pushing application is installed in a mobile device, and the pushing application comprising a receive module, receiving the message identification from the cloud pushing module, and deleting the repeated message identification; a connection module, establishing a connection with the message pushing server, providing the message identification and the verification token to the pushing server module when the message identification, and receiving the pushing message from the pushing server transmission module; and a display module, displaying the message identification and the pushing message.

According to the present invention, the message pushing method comprises steps of receiving a pushing message by a message pushing server, and generating a message identification corresponding to the pushing message; pushing the message identification to at least a pushing cloud by the message pushing server; pushing the message identification by the pushing cloud to a pushing application corresponding thereto, and the pushing application installed in a mobile device deletes the repeated message identification and displays the message identification; establishing a connection with the message pushing server by the pushing application, providing the message identification and a verification token to the message pushing server; verifying the message identification and the verification token by the message pushing server; transmitting the push message corresponding to the message identification to the pushing application by the message pushing server, when the message identification and the verification token passes a verification; and displaying the pushing message by the pushing application.

The system and method of the present invention has the difference as compared to the prior art that the message pushing server receives the push message and generate the message identification corresponding thereto, the pushing cloud pushes the message identification to the application corresponding thereto, the application provides the message identification and the verification token to the message pushing server for the verification, and then the message pushing server pushes the push message corresponding thereto to the application by using a safety connection. In addition to a relatively lower development cost, the message pushing may have a relatively higher safety since the push message is always stored in the message pushing server and thus will not be pushed to the cloud.

By using the above technical means, the present invention may achieve the technical efficacy of a lowered message pushing cost and an increased message pushing safety.

### BRIEF DESCRIPTION OF THE DRAWINGS

The present invention will be better understood from the following detailed descriptions of the preferred embodiments according to the present invention, taken in conjunction with the accompanying drawings, in which:

FIG. 1 is a system block diagram of a message pushing system according to the present invention;

FIG. 2 is a flowchart of a message pushing method according to the present invention;

FIG. 3 is a schematic diagram of an architecture for a message pushing according to the present invention;

FIG. 4 is a schematic diagram illustrating a message identification for the message pushed according to the present invention; and

FIG. 5 is a schematic diagram illustrating the message identification for the message pushed according to the present invention.

### DETAILED DESCRIPTION

The present invention will be apparent from the following detailed description, which proceeds with reference to the accompanying drawings, wherein the same references relate to the same elements.

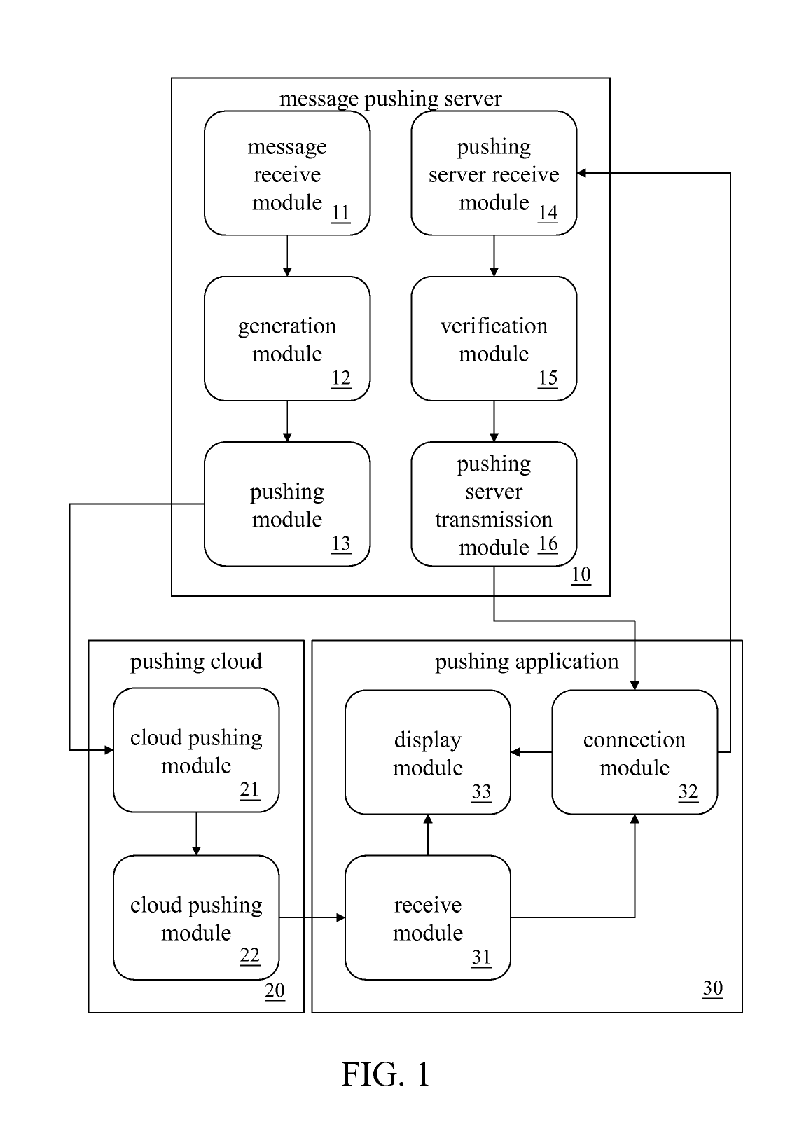

In the following, a message pushing system of the present invention will be first described, with reference to FIG. 1, in which a system block diagram of a message pushing system according to the present invention is shown.

The message pushing system of the present invention comprises a message pushing server 10, a pushing cloud 20 and a pushing application 30.

The message pushing server 10 comprises a message receive module 11, a generation module 12, a pushing module 12, a pushing server receive module 14, a verification module 15 and a pushing server transmission module 16. The pushing cloud 20 comprises a cloud receive module 21 and a cloud pushing module 22. The pushing application 30 is installed in a mobile device (not shown in the figure), the pushing application 30 comprises a receive module 31, a connection module 32 and a display module 33.

The message receive module 11 is used to receive a pushing message form an external system, in which the pushing message may be a monitoring system, an alarm system, etc., and the pushing message may be such as “station A has an yield of lower than 95%, station B is failed”, etc. However, these are merely examples without limiting the present invention. The pushing message provided by the external system is right pushed by the message pushing system of the present invention.

After the message receive module 11 receives the pushing message from the external system, the generation module 12 will generate a message identification corresponding to the pushing message, and the message identification generated by the generation module 12 is unique and not repeated. The message identification may be a combination of a number, a character, a symbol, etc., such as ABC123, or 123@#$ . . . However, these are merely examples, without limiting the present invention.

Thereafter, the pushing module 13 may push the message identification generated by the generation module 12 to at least a pushing cloud, so that the pushing server receive module 21 of each of the pushing clouds 20 may receives the message identification, and the cloud pushing module 22 of each of the pushing clouds 20 pushes the message identification to the pushing application 30 corresponding thereto.

Thereafter, the receive module 31 of the pushing application 30 may receive the message identification from each of the cloud pushing modules 22 and delete the repeated message identification. In this manner, the display module 33 may be used to display the message identification through the application 30 and thus a user carrying the mobile device may obtain the message identification.

Thereafter, after the user selects the display module 33 to display one of the message identifications, the connection module 32 of the pushing application 30 may establish a safety connection with the message pushing server 10, and the connection module 32 may provide the message identification and the verification token to the pushing server receive module 14 of the message pushing server 10. In the above, the verification token is established in the mobile device previously, and the verification token has a user name, a password, a hash value, etc. stored therein. However, these are merely examples without limiting the present invention.

Thereafter, after the pushing server receive module 13 receives the message identification and the verification token provided by the pushing application 30, the verification module 15 of the message pushing server 10 launches a verification process on the message identification and the verification token, where the verification tokens having different stored content are applicable to different verification manners. Assume the verification token has the user name and password stored therein, the verification module 15 verifies if the user name and password matches a predetermined content. Assume the verification token has a hash value stored therein, the verification module 15 matches if the hash value matches a predetermined value. However, these are merely examples without limiting the present invention.

After the verification made by the verification module 15 with respect to the message identification and the verification token is passed, the pushing transmission module 16 of the message pushing server 10 transmits the pushing message corresponding to the message identification to the connection module 32. After the connection module 32 receives the pushing message, the display module 33 displays the pushing message, so that the user carrying the mobile device may obtain the pushing message.

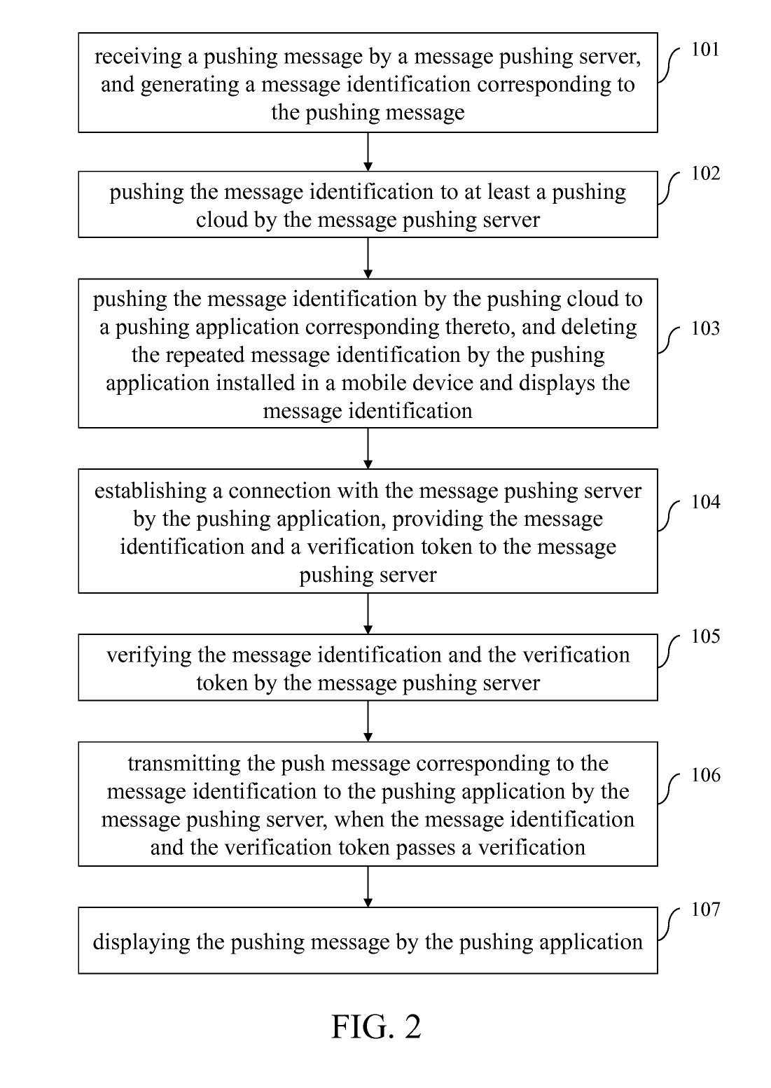

Thereafter, an embodiment will be set forth to explain how the present invention is operated, with simultaneous reference to FIG. 1 and FIG. 2, in which FIG. 2 is a flowchart of a message pushing method according to the present invention.

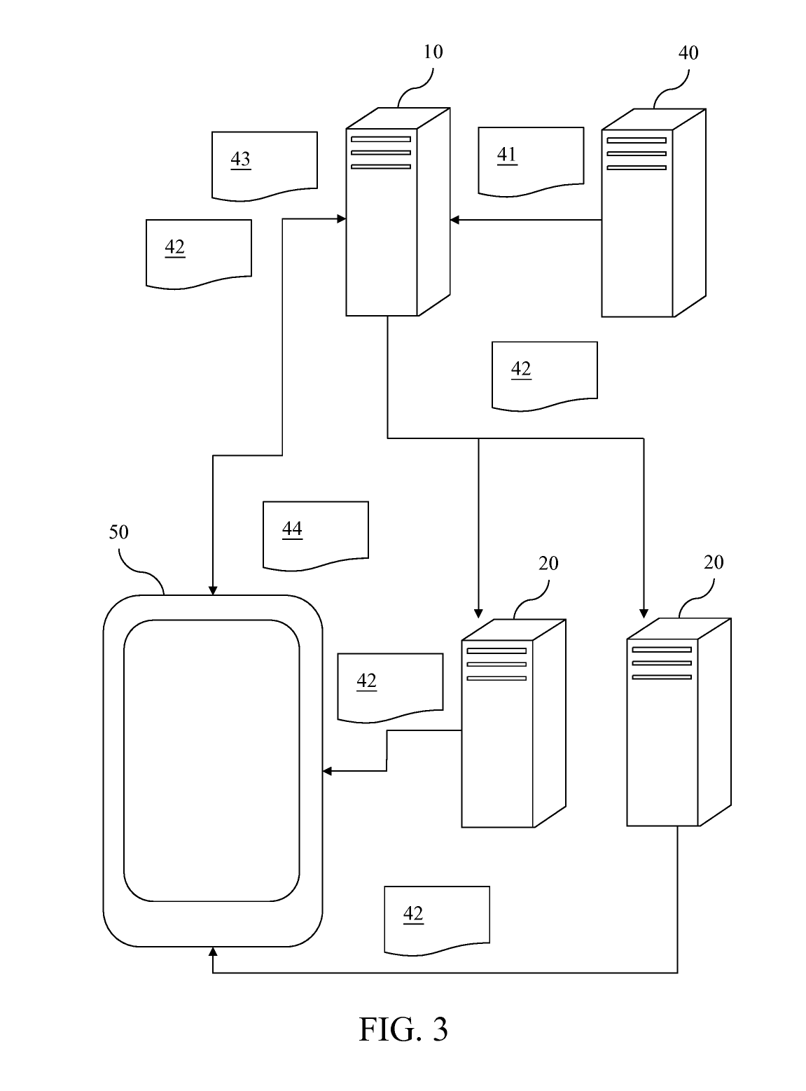

Referring to FIG. 3, a schematic diagram of an architecture for a message pushing according to the present invention is shown therein.

The message receive module 11 receives from the external system 40 the pushing message 41 “station A has its yield lower than 95%”. In this embodiment, the external system is a monitoring system; however, this is merely an example without limiting the present invention. The pushing message 41 provided by the external system is “station A has its yield lower than 95%”is pushed by the message pushing system of the present invention.

After the message receive module 11 receives the pushing message 41 from the external system 40 “station A has its yield lower than 95%”, the generation module 12 generates the message identification 42 “A-0010” corresponding to the pushing message “station A has its yield lower than 95%” 41 (S101), and the message identification 42 “A0010” generated by the generation module 12 is unique and not repeated. However, this is merely an example without limiting the present invention.

Thereafter, the pushing module 13 may push the message identification 42 generated by the generation module 12 to two pushing clouds 20 (S102). However, this is merely an example without limiting the present invention. The cloud receive module 21 of each of the pushing clouds 20 may receive the message identification 42 “A0010” from the pushing module 13, and then the cloud pushing module 22 of each of the pushing clouds 20 pushes the message identification “A-0010” 42 to the pushing application 30 corresponding thereto, wherein the pushing application 30 is installed in the mobile device 50 previously.

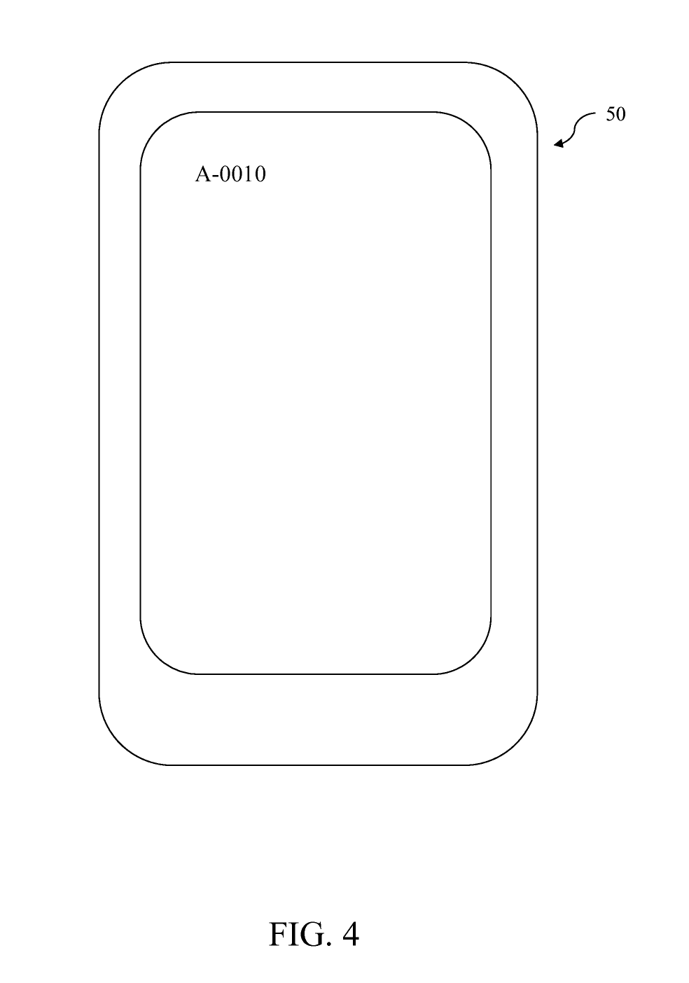

Thereafter, the receive module 31 of the pushing application 30 may receive the message identification “A0010” 42 from each of the cloud pushing module 22, the receive module 31 may receive two message identifications “A-0010” 42, in which the message identification 42 has its display shown as FIG. 4, which is a schematic diagram illustrating a message identification for the message pushed according to the present invention. The user carrying the mobile device 50 may obtain the message identification “A-0010” 42.

Thereafter, when the user selects the display module 33 to display the message identification “A-0010” 42, the connection module 32 of the pushing application 30 may establish a safety connection with the message pushing server 10, and the connection module 32 will provide the message identification “A-0010” 42 and the verification code “1F6B52CAEAAC2EBF” 43 to the pushing server module 14 of the message pushing server 10 (S104). In the above, the verification token 43 is 1F6B52CAEAAC2EBF” and established in the mobile device previously, and MD5 is exemplified as its hash value for description. However, this is merely an example without limiting the present invention.

Thereafter, after the pushing server receive module 14 receives the message identification “A0010” 42 provided by the pushing application 30 and the verification code 1F6B52CAEAAC2EBF″43, the verification module 15 of the message pushing server 10 launches a verification process on the message identification “A0010” 42 and the verification token “1F6B52CAEAAC2EBF”43 (S105).

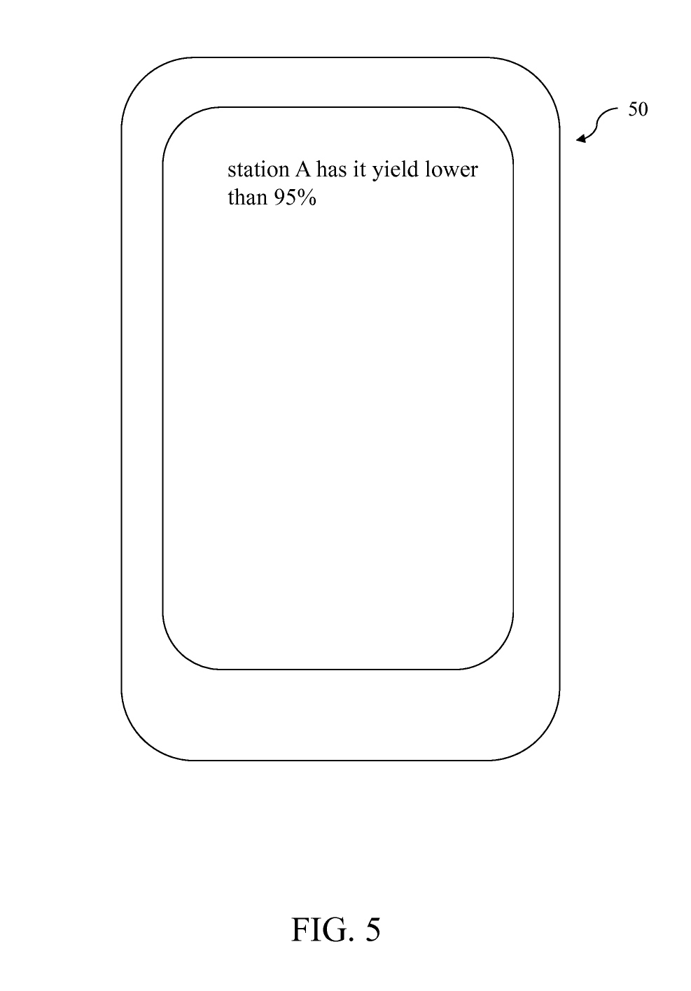

In this embodiment, the verification module 15 may pass its verification when the message identification 42 “A-0010” and the verification token “1F6B52CAEAAC2EBF”43 are encountered, then the pushing server transmission module 16 of the message pushing server 10 and the pushing message “station A has its yield lower than 95%”41 are transmitted to the connection module 32 (S106). And, after the connection module 32 receives the pushing message “station A has its yield lower than 95%”41, the display module 33 displays the pushing message 41 “station A has its yield lower than 95%” (S107). The display result of the pushing message 41 may be referred to FIG. 5, in which a schematic diagram illustrating the message identification for the message pushed according to the present invention is shown. At this time, the user carrying the mobile device may obtain the message identification “station A has its yield lower than 95%”41.

In summary, it may be known that the system and method of the present invention has the difference as compared to the prior art that the message pushing server receives the push message and generate the message identification corresponding thereto, the pushing cloud pushes the message identification to the application corresponding thereto, the application provides the message identification and the verification token to the message pushing server for the verification, and then the message pushing server pushes the push message corresponding thereto to the application by using a safety connection. In addition to a relatively lower development cost, the message pushing may have a relatively higher safety since the push message is always stored in the message pushing server and thus will not be pushed to the cloud.

By using the above technical means, the present invention may solve the issue of an exceedingly higher cost and a poor safety encountered in the prior art achieve the technical efficacy of a lowered message pushing cost and an increased message pushing safety.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A message pushing system, comprising:
a message pushing server, comprising:
a message receive module, receiving a pushing message;
a generation module, generating a message identification corresponding to the pushing message;
a pushing module, pushing the message identification to at least a pushing cloud;
a pushing server receive module, receiving the message identification and a verification token;
a verification module, verifying the message identification and the verification token; and
a pushing server transmission module, transmitting the pushing message corresponding to the message identification when the message identification and the verification token passes the verification;
the pushing cloud, comprises:
a cloud receive module, receiving the message identification from the message pushing server pushing module; and
a cloud pushing module, pushing the message identification to a pushing application corresponding thereto;
the pushing application is installed in a mobile device, comprises:
a receive module, receiving the message identification from the cloud pushing module, and deleting the repeated message identification;
a connection module, establishing a connection with the message pushing server, providing the message identification and the verification token to the pushing server module when the message identification is selected, and receiving the pushing message from the pushing server transmission module; and
a display module, displaying the message identification and the pushing message.

2. The message pushing system as claimed in claim 1, wherein the message identification is unique and not repeated.

3. The message pushing system as claimed in claim 1, wherein the pushing message is provided by an external system.

4. The message pushing system as claimed in claim 1, wherein the connection module establishes a safety connection with the message pushing server.

5. The message pushing system as claimed in claim 1, wherein the pushing cloud further comprises a processing module, deleting the message identification when the message identification is pushed to the pushing application corresponding thereto, while the cloud pushing module pushes the message identification again to the pushing application corresponding thereto when the message identification is not pushed to the pushing application corresponding thereto for a predetermined time period.

6. A message pushing method, comprising steps of:
receiving a pushing message by a message pushing server, and generating a message identification corresponding to the pushing message;
pushing the message identification to at least a pushing cloud by the message pushing server;
pushing the message identification by the pushing cloud to a pushing application corresponding thereto, and deleting the repeated message identification by the pushing application installed in a mobile device and displays the message identification;
establishing a connection with the message pushing server by the pushing application, providing the message identification and a verification token to the message pushing server;
verifying the message identification and the verification token by the message pushing server;
transmitting the push message corresponding to the message identification to the pushing application by the message pushing server, when the message identification and the verification token passes a verification; and
displaying the pushing message by the pushing application.

7. The message pushing method as claimed in claim 6, wherein, in the step of receiving the pushing message by a message pushing server and generating the message identification corresponding to the pushing message, the push message identification is unique and not repeated.

8. The message pushing method as claimed in claim 6, wherein, in the step of receiving the pushing message by a message pushing server and generating the message identification corresponding to the pushing message, the push message is provided by an external system.

9. The message pushing method as claimed in claim 6, wherein, in the step of establishing the connection with the message pushing server, providing the message identification and the verification token to the message pushing server, the pushing application establishes a safety connection with the message pushing server.

10. message pushing method as claimed in claim 6, further comprising steps of:
deleting the message identification by the pushing cloud when the message identification is pushed to the pushing application corresponding thereto, and
the pushing cloud pushes the message identification again to the pushing application corresponding thereto when the message identification is not pushed to the pushing application corresponding thereto for a predetermined time period.
